(19) United States
(12) Patent Application Publication
(10) Pub. No.: US 2005/0107034 A1
(43) Pub. Date: May 19, 2005

(54) Repeater for mobile communications system

(75) Inventors: Gi Young Lee, Seoul (KR); Chul Kwoun, Seoul (KR)

Correspondence Address: BRUCE E. LILLING;LILLING & LILLING P.C., P.O. BOX 560, GOLDEN BRIDGE, NY, 10526, US

(73) Assignee: GS Teletech Co., Ltd., Seoul (KR)

(21) Appl. No.: 10/984,070

(22) Filed: Nov. 9, 2004

(30) Foreign Application Priority Data
Nov. 13, 2003 (KR) 10-2003-0080337
Jul. 29, 2004 (KR) 10-2004-0059761

(51) Int. Cl. H04B 7/15

(52) U.S. Cl. 455/11.1

(57) ABSTRACT

The present invention relates to a repeater for amplifying signals transmitted and received between a communications terminal such as cellular phone and a base station and, more particularly, to a repeater for mobile communications system, which amplifies the signal received from the communications terminal accommodatively to intensity of the signal, or correlatively with the existence of the input signal, and transmits the amplified signal to the base station. The repeater of the invention establishes a line coupler 7 on a transmission line for a first amplifier 5 amplifying the frequency signal received from the terminal and divides the frequency signal input to the first amplifier 5. A gain control signal generator 8 generates a gain control signal corresponding proportionally to a level of the frequency signal divided by the line coupler 7 and applies the gain control signal to the first amplifier 5. Here, the first amplifier 5 sets a gain level of the frequency signal to be transmitted to the base station variably, or decides whether to transmit, based on the gain control signal.

### BACKGROUND OF THE INVENTION

1. Field of the Invention

The present invention relates to a repeater for amplifying signals transmitted and received between a communications terminal such as cellular phone and a base station and, more particularly, to a repeater for mobile communications system, which amplifies the signal received from the communications terminal accommodatively to intensity of the signal, or correlatively with the existence of the input signal, and transmits the amplified signal to the base station.

2. Description of the Related Art

Recently, a mobile communications system, through which users can execute voice phone calls and data transmission/reception in motion, has been rapidly developed and widely used. The mobile communications system divides the call area in the unit of cell and establishes a base station at each cell unit, so users can execute communications through the base station(s). The base station and the terminal transmit and receive data using a frequency signal from hundreds of MHz to several GHz and plural repeaters are established in places considering communications shadow region such as the indoor, etc.

The repeater amplifies a signal (forward direction link signals) from the base station and transmits the amplified signal to the terminal and amplifies a signal (backward direction link signals) from the terminal and transmits the amplified signal to the base station, thus accomplishing satisfied data communications between the base station and the terminal. Especially, the repeater detects transmission loss between the base station and the repeater based on the intensity of signal received from the base station and, then, adjusts amplification gain of signal received from the terminal based on the detected result, thus setting the intensity of signal an appropriate level to be transmitted from the terminal to the base station by way of the repeater.

Meanwhile, the number of repeaters coupled within one cell, i.e., to one base station increases tremendously as the number of newly-built high-rise buildings and apartment buildings increases, which deteriorates the receive sensitivity of the base station.

That is, the conventional repeater transmits signals continuously to the base station regardless of the existence of the backward direction link signal applied from the terminal since it amplifies the backward direction link signal based on the intensity of the forward direction link signal received from the base station. Namely, the conventional repeater transmits a noise signal having a predetermined intensity if there is no backward direction link signal from the terminal. Accordingly, if the intensity of common white noise is −128 dBm and the amplification gain of backward direction link of the repeater is 60 dBm for example, and if there is no backward direction link signal from the terminal, a noise signal of −68 dBm approximately is transmitted from the repeater to the base station. In view of only one repeater, since the transmission loss from the repeater to the base station is approximately 70 to 100 dBm, the intensity of the noise signal received from the repeater to the terminal comes up to −138 dBm in maximum, which the base station can disregard. However, it the number of repeaters coupled to the base station increases more than a specified number, the number of noise signals received to the base station increases rapidly, thus increasing the intensity of the noise signal due to the overlap of the noise signals, etc. The increase of the noise signal intensity deteriorates the receive sensitivity of the base station remarkably.

Since the above problem occurs identically in optical repeaters as well as in the RF repeaters and the number of repeaters coupled to one base station should be restricted within a specified number, it is very difficult to provide users with the best phone call quality.

### BRIEF SUMMARY OF THE INVENTION

Accordingly, an object of the present invention is to provide a repeater for mobile communications system, which can minimize the deterioration of receive sensitivity resulting from the transmission of noise signals in the base station.

In addition, another object of the present invention is to provide a repeater for mobile communications system, which can minimize electric power consumption by minimizing the signal transmission time required.

To accomplish an object in accordance with a first aspect of the present invention, there is provided a repeater for mobile communications system for amplifying data transmitted and received between a terminal and a base station, the repeater comprising: a service antenna for transmitting and receiving a frequency signal to and from a terminal; a first amplifying means for amplifying the frequency signal received through the service antenna; a transmitting means for transmitting the frequency signal amplified by the first amplifying means to the base station; and a gain control signal generating means for generating a gain control signal corresponding proportionally to a level of the frequency signal input to the first amplifying means, the first amplifying means amplifying input frequency signal based on the gain control signal generated by the gain control signal generating means.

Besides, the gain control signal generating means includes: a second amplifying means for amplifying input frequency signal with a non-linear gain characteristic; and a bias means for outputting a driving current having a level corresponding to the output of the second amplifying means.

To accomplish another object in accordance with a second aspect of the present invention, there is provided a repeater for mobile communications system for amplifying data transmitted and received between a terminal and a base station, the repeater comprising: a service antenna for transmitting and receiving a frequency signal to and from a terminal; a first amplifying means for amplifying the frequency signal received through the service antenna; a transmitting means for transmitting the frequency signal amplified by the first amplifying means to the base station; and a gain control signal generating means for generating a gain control signal of high or low level based on a level of the frequency signal input to the first amplifying means, the first amplifying means being turned on/off based on the gain control signal.

In addition, the gain control signal generating means including: an integrating means for outputting a signal having a level corresponding to an intensity of the frequency signal input; a third amplifying means for amplifying the output of the integrating means; a comparing means for outputting a detecting signal of high or low level by comparing the output level of the third amplifying means with a specified standard level; and a switching means, turned on/off based on the output of the comparing means, for outputting a gain control signal of high or low level for the first amplifying means.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a block diagram showing a repeater for mobile communications system in accordance with a preferred embodiment of the present invention;

FIG. 2 is a graph illustrating an example of amplification gain characteristics of a first amplifier 5 in FIG. 1;

FIG. 3 is a diagram depicting a concrete configuration of a gain control signal generator 8 in FIG. 1;

FIG. 4 is a graph illustrating operation characteristics of a log amplifier 81 in FIG. 2;

FIG. 5 is a block diagram showing another repeater for mobile communications system in accordance with another embodiment of the present invention; and

FIG. 6 is a diagram depicting another concrete configuration of the gain control signal generator 8 in FIG. 1.

### DETAILED DESCRIPTION OF THE INVENTION

Reference will now be made in detail to the preferred embodiments of the present invention, examples of which are illustrated in the accompanying drawings.

Besides, the present can apply to the common RF repeater and to the optical repeater identically, however, below explanation will be made based on the RF repeater.

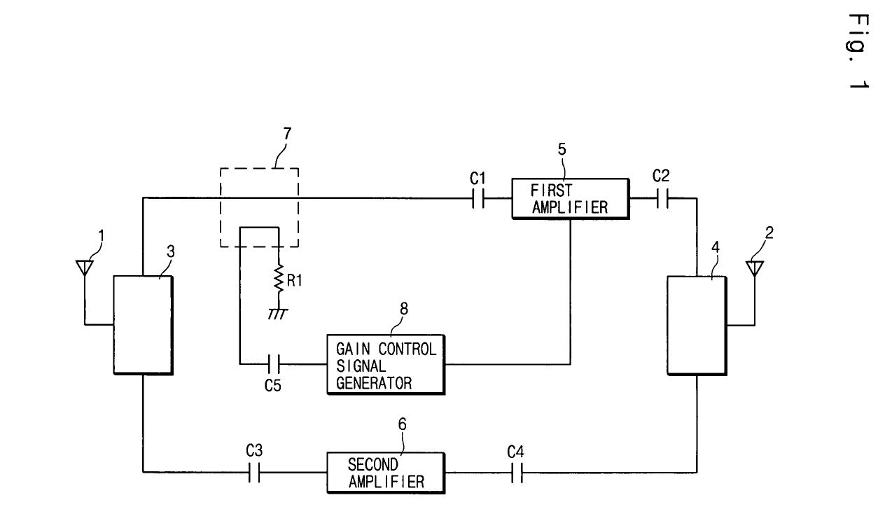

FIG. 1 is a block diagram showing a repeater for mobile communications system in accordance with a preferred embodiment of the present invention. In FIG. 1, reference numeral 1 denotes a service antenna for transmitting and receiving data to and from the terminal and numeral 2 denotes a donor antenna for transmitting and receiving data to and from the base station. First and second duplex filters 3 and 4 for separating received frequency signals from frequency signals to be transmitted are coupled to the service and donor antennas 1 and 2, respectively. First and second amplifiers 5 and 6 for amplifying transmit/receive frequency signals are connected through coupling condensers C1 to C4 with the duplex filters 3 and 4. The antennas 1 and 2, the first and second duplex filters 3 and 4, and the first and second amplifier 5 and 6 are substantially identical with those adopted in the common repeater.

In the above configuration, the frequency signal received through the service antenna 1 from the terminal is applied through the first duplex filter 3 to the first amplifier 5 and amplified by the amplifier 5. Amplified frequency signal is transmitted to the base station by way of the second duplex filter 4 and the donor antenna 2. The frequency signal received through the antenna 2 from the base station is applied through the second duplex filter 4 to the second amplifier 6 and amplified by the amplifier 6. Amplified frequency signal is transmitted to the terminal through the first duplex filter 3 and the service antenna 1.

A line coupler 7 is established on a transmission line between the first duplex filter 3 and the first amplifier 5. The line coupler 7 has another line (referred to as Θinduce line” hereinafter) positioned adjacent to the transmission line between the first duplex filter 3 and the first amplifier 5. An end of the induce line is grounded through a resistor R1 and the other end is connected to a gain control signal generator 8, described hereinafter, through a coupling condenser C5. The resistor R1 is used for impedance matching with the gain control signal generator 8. When the frequency signal input through the first duplex filter 3 from the terminal are transmitted to the first amplifier 5 through the transmission line, induced current having a level corresponding to the level of the frequency signal transmitted through the transmission line is generated on the induce line of the line coupler 7 and input to the gain control signal generator 8.

The gain control signal generator 8 generates a gain control signal corresponding proportionally to the level of the signal applied from the line coupler 7 is and applies the gain control signal to the first amplifier 5. That is, if the level of induced signal input through the line coupler 7 is high according as a signal is input from the terminal, the gain control signal generator 8 generates a gain control signal for increasing the amplification gain of the first amplifier 5, whereas, if the level of induced signal input through the line coupler 7 is low according as there is no signal input, the generator 8 generates a gain control signal for setting the amplification gain low or for suspending the amplification operation.

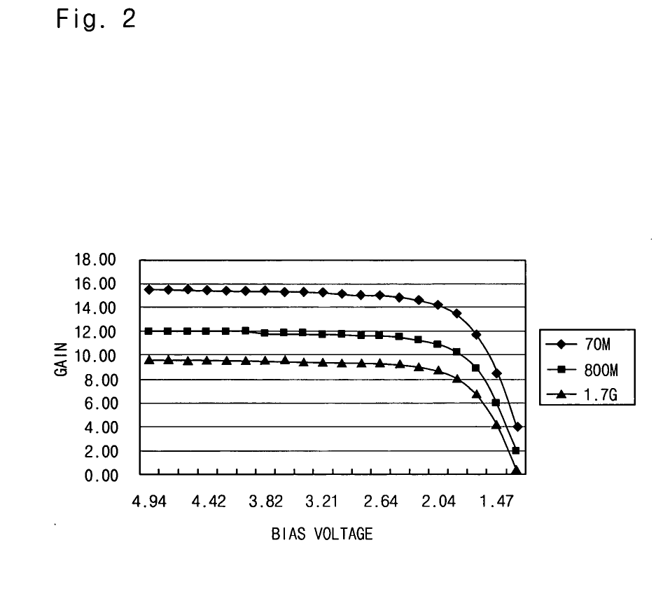

The first amplifier 5 is composed of plural amplifiers coupled in series with each other for establishing appropriate amplification gains. The amplifier is a device of Model No. AH1 manufactured by W J Communications INC, for example. FIG. 2 is a graph illustrating amplification gain characteristics of the AH1 amplifier. If bias voltage applied from the gain control signal generator 8 is 2.04 to 5V, the AH1 amplifier has amplification gain about 18 to 10 dB against input frequency signal having about 70 MHz to 1.7 GHz band. If bias voltage is lowered less than 2.0V, the amplification gain is rapidly lowered. The amplification gain characteristic described above is identically shown in other amplifiers than the AH1 device.

If the gain control signal applied from the gain control signal generator 8 is set to more than a specified level, the first amplifier 5 amplifies frequency signal input from the first duplex filter 3. The amplified signal is transmitted to the base station by way of the second duplex filter 4 and the donor antenna 2. Besides, if the gain control signal applied from the gain control signal generator 8 is set to less than the specified level, the amplification gain of the first amplifier 5 is set to nearly 0 dB. That is, the first amplifier 5 is set substantially to an off-drive status. In this case, the first amplifier 5 outputs input signal as it is without amplification or interrupts outputting of the input signal.

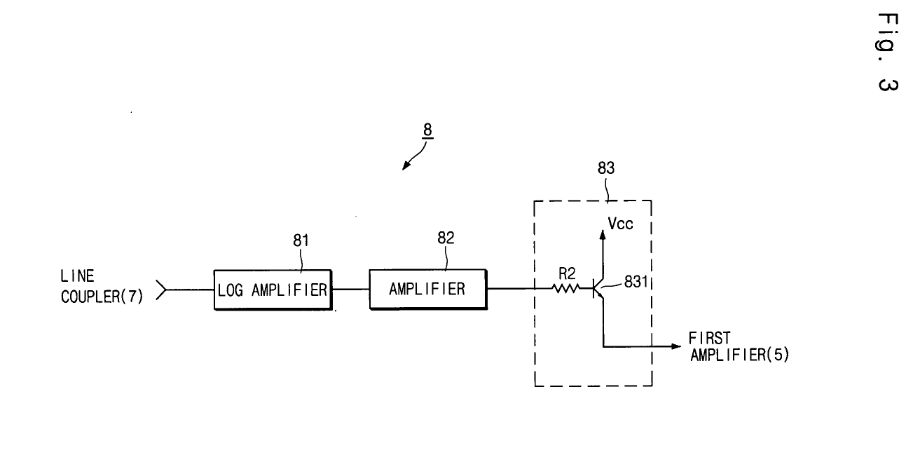

Meanwhile, FIG. 3 is a diagram depicting a concrete configuration of the gain control signal generator 8. The gain control signal generator 8 includes a log amplifier 81 outputting a specified level signal corresponding to the intensity of input frequency signal; an amplifier 82 amplifying the level signal output from the log amplifier 81; and a bias circuit 83 having a resistor R2 and a transistor 831.

The log amplifier 81 is a device of Model No. AD8314 manufactured by Analog Devices, Inc., for example. The log amplifier 81 generates a specified level signal corresponding to the intensity of input frequency signal by integrating the signal and amplifies the signal with a non-linear gain characteristic.

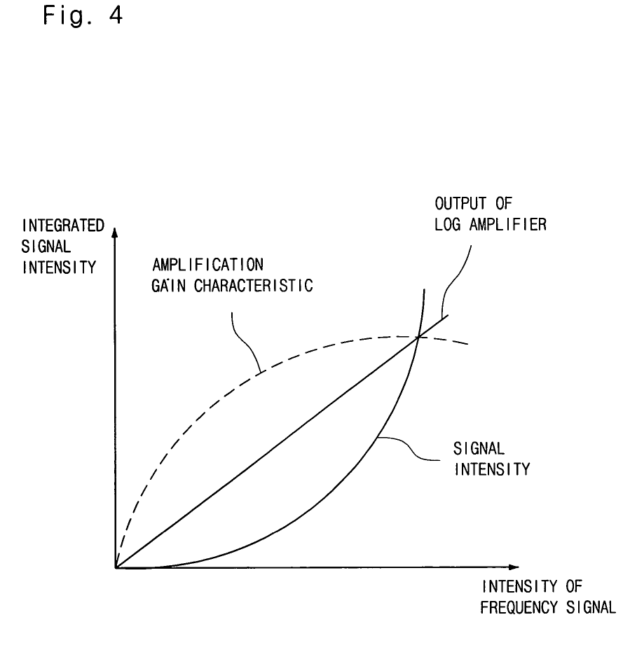

FIG. 4 is a graph illustrating operation characteristics of the log amplifier 81. In general, if the frequency signal transmitted from the terminal is integrated, integrated signal is not varied linearly according to the intensity of frequency signal, but has a characteristic of exponential function according to the intensity of frequency signal, as depicted with a solid curve line in FIG. 4. The log amplifier 81 amplifies input signal with a complementary gain characteristic, as depicted with a dotted line, for a characteristic that the intensity of signal has, as depicted with the solid curve line. Accordingly, the log amplifier 81 outputs amplified signal having a linear output level according to the intensity of input signal.

Then, the output of the log amplifier 81 is amplified to a specific level by the amplifier 82 and sent to the bias circuit 83. In the bias circuit 83, the output of the amplifier 82 is coupled to a base of the transistor 831 through the resistor R2 and the transistor 831 sends an output corresponding to the signal level coupled to the base to the first amplifier 5 as a gain control signal.

That is, the gain control signal generator 8 generates a gain control signal proportional to the level of input frequency signal by driving the bias circuit 83 linearly based on the intensity of frequency signal input from the line coupler 7.

Hereinafter, description will be made as for the operation of the repeater having the above configuration in accordance with the invention.

The frequency signal transmitted from the base station to the repeater is input to the second amplifier 6 by way of the donor antenna 2 and the second duplex filter 4 in the same manner with the common repeater. Then, the signal amplified by the second amplifier 6 is sent to the terminal by way of the first duplex filter 3 and the service antenna 1.

Meanwhile, the frequency signal including a white noise received through the service antenna 1 is applied to the first amplifier 5 through the first duplex filter 3. The first amplifier 5 amplifies the frequency signal based on the gain control signal output from the gain control signal generator 8 and transmits the amplified signal to the base station by way of the second duplex filter 4 and the donor antenna 2.

If the frequency signal transmitted from the terminal is received through the service antenna 1, an induced signal having more than a specified intensity is induced through the line coupler 7 and applied to the gain control signal generator 8. Then, the gain control signal generator 8 generates a gain control signal having more than a specified level and supplies the signal with the first amplifier 5 as a bias voltage as described above. Next, the first amplifier 5 amplifies the frequency signal input through the service antenna 1 with a high amplification gain and outputs the amplified signal to the donor antenna 2.

Besides, if there is received no frequency signal from the terminal, the induced signal induced through the line coupler 7 and applied to the gain control signal generator 8 is set to less than the signal intensity corresponding to the white noise. Then, the level of the gain control signal output from the gain control signal generator 8 is set to “0” or nearly “0”. Accordingly, the amplification gain of the first amplifier 5 is set to nearly 0 dB or the first amplifier 5 is set to an off-driving status. As a result, the signal intensity output from the first amplifier 5 to the donor antenna 2 is set to a very low level less than the white noise level.

Meanwhile, if a frequency signal is received from the terminal through the service antenna 1 on a sudden under the condition that there exists no frequency signal from the terminal, that is, under the condition that the first amplifier 5 is set to the off-driving status, the frequency signal is applied to the first amplifier 5, in which the amplification gain is set to nearly 0 dB. And, at the same time, an induced signal corresponding proportionally to the intensity of the input frequency signal is induced by the line coupler 7 and sent to the gain control signal generator 8. Then, a gain control signal generated by the gain control signal generator 8 sets the amplification gain of the first amplifier 5 a normal status.

Here, approximately 100 ns delay time is needed to output a gain control signal having more than a specified level from the gain control signal generator 8 after the induced signal is applied and about 700 ns delay time is required until the amplification gain of the first amplifier 5 reaches a normal gain from 0 dB. Accordingly, the frequency signal input from the terminal to the first amplifier 5 loses initial data of about 800 ns section, not transmitted to the base station.

In general, the channel used for the backward direction link from the terminal to the base station includes an access channel and a traffic channel. Here, since the access channel has priority for transmitting the channel signal from the terminal to the base station, the delay time required by the gain control signal generator 8 and the first amplifier 5 may affect the access channel data, especially. However, in case of the access channel, data transmission rate is fixed to 4.8 Kbps for example and the access channel data are transmitted by dividing into preamble data and capsule data for a precise data transmission and reception. Here, since the preamble data is composed of four preamble data having a time length of 1.25 ms each, the signal section of the preamble data is set about 5 ms in total. Accordingly, since the delay time required by the gain control signal generator 8 and the first amplifier 5 is less than the time corresponding to one preamble data, there is no probability that a normal service is not provided with the terminal by forming an abnormal backward direction link.

In the preferred embodiment of the invention as described above, the amplification gain of the signal to be transmitted to the base station is set variably and correlatively with the existence of the frequency signal received through the service antenna 1, thus solving a problem that the repeater transmits noise signals having more than a specified level continuously to the base station.

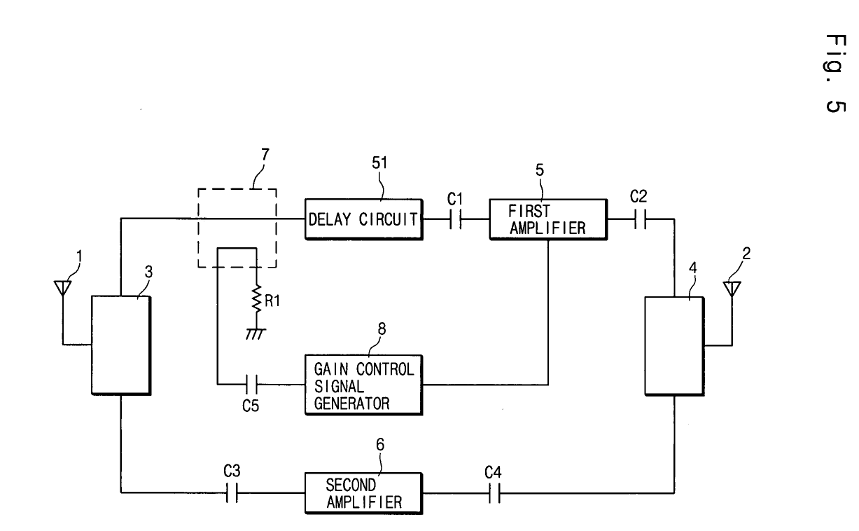

FIG. 5 is a block diagram showing another repeater for mobile communications system in accordance with another embodiment of the present invention. Substantially identical elements with those described in FIG. 1 have the same reference numerals and detailed explanation will be omitted.

A delay circuit 51 for delaying frequency signal input from the terminal through the service antenna 1 for a predetermined time is established between the line coupler 7 and the first amplifier 5. The delay circuit 51 delays the frequency signal to be applied to the first amplifier 5 for a certain time corresponding to the delay time required by the gain control signal generator 8 and the first amplifier 5, i.e., the delay time to output a gain control signal corresponding to the induced signal applied to the gain control signal generator 8 and the delay time required until the amplification gain of the first amplifier 5 reaches a normal gain from 0 dB. With the delay circuit 51 of the preferred embodiment of the invention delaying the frequency signal applied through the line coupler 7 to the first amplifier 5 for a predetermined time as described above, it is possible to solve the problem that the initial data of the frequency signal to be transmitted from the terminal is not delivered to the base station due to the delay time required by the gain control signal generator 8 and the first amplifier 5, thus increasing reliance of the repeater of the invention.

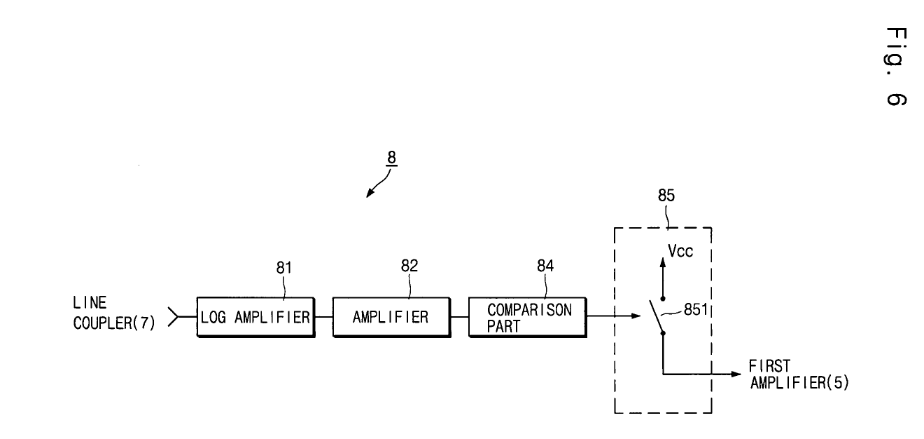

Next, FIG. 6 is a diagram depicting another concrete configuration of the gain control signal generator 8 in FIG. 1. Substantially identical elements with those described in FIG. 3 have the same reference numerals and detailed explanation will be omitted.

The gain control signal generator 8 in FIG. 6 includes a comparison part 84 for detecting whether the output from the amplifier 82 has more than or less than a specified level, or outputting a detecting signal of high or low level, instead of the bias circuit 83, and a switching part 85 having a switch 851 turned on/off according to the output level of the comparison part 84. In this configuration, if the signal output from the amplifier 82 has more than the specified level, i.e., data is received from the terminal by way of the service antenna 1 and the duplex filter 3 in FIG. 1, the switch 851 of the switching part 85 is turned on and a gain control signal having a specified level is applied to the first amplifier 5. Contrarily, if the signal output from the amplifier 82 has less than the specified level, i.e., data is not received from the terminal, the switch 851 of the switching part 85 is turned off and a gain control signal of “0” level is applied to the first amplifier.

Accordingly, when the gain control signal generator 8 depicted in FIG. 6 is adopted to the configuration of FIG. 1, the first amplifier 5 is driven with a predetermined amplification gain to transmit the frequency signal to the base station if there exists received data from the terminal, whereas, the first amplifier 5 is driven with the amplification gain of 0 dB to suspend transmission of the frequency signal to the base station if there exists no received data from the terminal.

According to the present invention described above, if there exists no signal from the terminal to the repeater, the signal level transmitted from the repeater to the base station is set to low, or data transmission is suspended, whereas, if there exists received signal from the terminal to the repeater, transmission signal of normal level is delivered from the repeater.

Therefore, in case that plural repeaters are coupled to one base station, the repeaters are not set to driving status at all times, but driven selectively when there exists transmission signal, thus preventing deterioration of receive sensitivity of the base station due to the noise signal delivered from the repeaters.

Besides, since the repeater is selectively driven according to the existence of the transmission signal, it is possible to reduce electric power consumption of the repeater.

In addition, the present invention is not limited to the embodiments described above and various modifications and variations can be made in the above-preferred embodiments of the invention.

For example, in the above-described embodiments, the amplification gain of the repeater for the base station is set based on the existence of the received signal from the terminal; however, it is possible to apply the gain control means, at the same time, for adjusting the amplification gain of the signal transmitted to the base station based on the signal level received from the base station.

Furthermore, in the above-described embodiments, it is possible to calculating availability efficiency of the repeater by detecting the output levels of the bias circuit 83 or switching part 851.

Moreover, in the above-described embodiments, description was made taking an example of the RF repeater; however, the present invention can be applied to the common optical repeater in the same manner.

Besides, in the above-described embodiment depicted in FIG. 4, it is possible to generate the gain control signal by integrating and linearly amplifying the level of input frequency signal and by deciding whether the amplified level is more than or less than a specified level, not adopting the log amplifier 81.

It will be apparent to those skilled in the art that various modifications and variations can be made in the repeater for mobile communications system of the present invention without departing from the spirit or scope of the invention. Thus, it is intended that the present invention cover the modifications and variations of this invention provided they come within the scope of the appended claims and their equivalents.

1. In a repeater for mobile communications system for amplifying data transmitted and received between a terminal and a base station, the repeater comprising:
a service antenna for transmitting and receiving a frequency signal to and from a terminal;
a first amplifying means for amplifying the frequency signal received through the service antenna;
a transmitting means for transmitting the frequency signal amplified by the first amplifying means to the base station; and
a gain control signal generating means for generating a gain control signal corresponding proportionally to a level of the frequency signal input to the first amplifying means,
the first amplifying means amplifying input frequency signal based on the gain control signal generated by the gain control signal generating means.

2. The repeater for mobile communications system as recited in claim 1,
wherein the gain control signal generating means includes: a second amplifying means for amplifying input frequency signal with a non-linear gain characteristic; and
a bias means for outputting a driving current having a level corresponding to the output of the second amplifying means.

3. The repeater for mobile communications systems as recited in claim 1, wherein a delaying means for delaying the frequency signal input to the first amplifying means is further established in front of the first amplifying means.

4. In a repeater for mobile communications system for amplifying data transmitted and received between a terminal and a base station; the repeater comprising:
a service antenna for transmitting and receiving a frequency signal to and from a terminal;
a first amplifying means for amplifying the frequency signal received through the service antenna;
a transmitting means for transmitting the frequency signal amplified by the first amplifying means to the base station; and
a gain control signal generating means for generating a gain control signal of high or low level based on a level of the frequency signal input to the first amplifying means,
the first amplifying means being turned on/off based on the gain control signal.

5. The repeater for mobile communications systems as recited in claim 4,
wherein the gain control signal generating means including: an integrating means for outputting a signal having a level corresponding to an intensity of the frequency signal input;
a third amplifying means for amplifying the output of the integrating means;
a comparing means for outputting a detecting signal of high or low level by comparing the output level of the third amplifying means with a specified standard level; and
a switching means, turned on/off based on the output of the comparing means, for outputting a gain control signal of high or low level for the first amplifying means.

6. The repeater for mobile communications systems as recited in claim 4,
wherein a delaying means for delaying the frequency signal input to the first amplifying means is further established in front of the first amplifying means.
